(19) United States
(12) Patent Application Publication
(10) Pub. No.: US 2008/0066782 A1
(43) Pub. Date: Mar. 20, 2008

(54) Turbulent Flow Washing Apparatus and Method

(75) Inventor: Terrence R. Langford, Tucson, AZ (US)

Correspondence Address: QUARLES & BRADY LLP, ONE SOUTH CHURCH AVENUE, SUITE 1700, TUCSON, AZ, 85701-1621, US

(73) Assignee: LANGFORD IC SYSTEMS, INC., Tucson, AZ (US)

(21) Appl. No.: 11/576,657

(22) PCT Filed: Oct. 6, 2004
(86) PCT No.: PCT/US04/32833

§ 371 Date: Apr. 4, 2007

(51) Int. Cl. B08B 3/10; B08B 5/04

(52) U.S. Cl. 134/21; 134/182; 134/34

(57) ABSTRACT

Methods and apparatus utilizing turbulent fluid flow to wash soiled items. A washing chamber (2) is connected to a pump (10) and contains a baffle (5) that divides or partially divides the chamber (2). The baffle (5) contains one or more openings (12) through which fluid surges in response to pressure generated by the pump (10). By using a reciprocating piston or diaphragm-type pump, back-and-forth fluid flow is generated. The fluid turbulence created by the fluid surging through the baffle openings creates a “scrubbing action” upon the surface of the items being washed.

### BACKGROUND OF THE INVENTION

1. Field of the Invention

This invention relates generally to methods and apparatus used to clean items and more particularly to devices and methods that utilize fluid turbulence to wash soiled surfaces.

2. Description of the Related Art

Many apparatuses exist that agitate (e.g., most washing machines), spray (e.g., dishwashers) or otherwise distribute water upon items in need of cleaning. Of the devices that utilize agitation to effect cleaning, items are typically submerged in a chamber filled with water while rotating blades or vibrations of the agitator produce fluid turbulence. In contrast, devices utilizing spray arms or nozzles direct pressurized water at the exterior of items placed in holding areas (e.g., racks) but do not submerge or subject the items to fluid turbulence.

While these related-art devices are suitable for their intended purposes, they often suffer from disadvantages such as unreliable cleaning of soil not directly in a spray path, copious water and electricity consumption, and wear on moving parts. Furthermore, items containing difficult soiling may have to be soaked or pretreated before actually washing. Moreover, items that are not properly cleaned the first time must be processed again by hand or run through another cycle, leading to wasted labor, resources, and time.

In addition to cleaning efficacy, resource consumption, wear, and labor issues, environmental concerns over the content of wash or rinse water effluent have become more pronounced as the detrimental effects of various detergents or other cleaning chemicals are now better understood. For example, detergents that contain phosphates are known to have adverse environmental effects, such as toxicity to aquatic organisms. Since most washing and cleaning applications are accomplished with various detergents (alone or in combination with other agents, such as bleaches, borax, or rinsing agents), harmful chemical residue can be left behind in the wash or rinse effluent. Therefore, discharge of these chemicals into rivers, lakes, and even sewer systems raises environmental concerns.

Thus, there continues to be a need for a washing apparatus and method that effectively cleans an item while lessening the possibility that excessive labor, water, power, pretreatment, detergents, and other chemicals will be required.

### SUMMARY OF THE INVENTION

The invention generally involves apparatuses and methods for generating turbulent fluid flow over items in need of cleaning, such as household items, dishes, etc., by placing or securing them in a chamber containing a baffle with one or more openings and then surging water (or another fluid) back-and-forth through the opening or openings in the baffle. Accordingly, a “scrubbing action” is created when fluid passes through the baffle opening(s), making the apparatus and method useful for a wide range of applications ranging from dish washing to exterior treatment of various instruments, tools, and implements.

In one aspect of the invention, a method for washing an item is provided in which the item is placed into a enclosed chamber that is at least partially divided by a baffle, wherein the baffle contains at least one opening therethrough. Fluid is then circulated through said chamber such that the fluid flows through the opening (or openings) of the baffle, thereby generating a turbulent fluid flow over an exterior of the item being washed.

Given the need to conserve natural resources, energy, and to protect the environment, high efficiency and well-performing washing appliances are in demand. The general concept underlying the invention is that washing items with a turbulent fluid flow helps to ensure that the item will be cleaned efficaciously, thereby reducing the need for additional cleaning, pre-treatment, use of detergents, and the like.

In one embodiment of the apparatus of the invention, a pressurize-able chamber is divided by a baffle containing at least one opening therethrough. The chamber is operably connected to a means for generating pressure on the fluid within the chamber such that a turbulent fluid flow is produced over an exterior of an item as a result of fluid flowing through the baffle opening or openings.

The means for generating pressure includes any known pump, such as diaphragm or a reciprocating piston. One or more pumps may generate the pressure sufficient such that an alternating flow of fluid (i.e., back-and-forth between the areas divided by the baffle) is generated through the baffle opening(s).

The opening(s) of the baffle may be generally cylindrical, other regular geometric shapes, spiraled, or transversely varied in diameter. In this context, non-circular shapes (e.g., square, polygonal, etc.) can be said to have an effective diameter. Moreover, the baffle may contain openings of different sizes and/ two or more different transverse diameters. Furthermore, the baffle itself may vary in thickness or in uniformity of thickness.

Thus, it is a primary objective of the invention to provide a washing method that improves cleaning efficacy.

Further, an object of the invention is to provide a washing method that effectively cleans while reducing the need for excessive chemicals or pretreatments.

An additional object of the invention is to provide a washing method that is economical to utilize in terms of natural resource consumption.

Still another object of the invention is to provide a washing method that may be practiced in conjunction with a wide variety of cleaning apparatuses.

In accordance with these and other objects, there are provided new and improved washing methods and apparatus that utilize a baffle placed within a washing chamber to produce turbulent fluid flow over soiled items. The method is especially useful in apparatuses used to clean dishes, household implements, a variety of instruments, and the like.

Various other purposes and advantages of the invention will become clear from its description in the specification that follows. Therefore, to the accomplishment of the objectives described above, this invention includes the features hereinafter fully described in the detailed description of the preferred embodiments, and particularly pointed out in the claims. However, such description discloses only some of the various ways in which the invention may be practiced.

### BRIEF DESCRIPTION OF THE DRAWINGS

FIG. 1 schematically illustrates a top view of the inside of a first embodiment of the invention.

FIG. 2 schematically illustrates a front view of the baffle from the apparatus of FIG. 1.

FIG. 3 schematically illustrates in enlarged cross-section the baffle of FIG. 2 taken along line 3-3.

FIG. 4 schematically illustrates a front view of the interior of a horizontally divided dishwashing embodiment of the invention.

FIG. 5A schematically illustrates a top view of a third embodiment of the invention showing a fluid surge into a first direction.

FIG. 5B is the embodiment illustrated in FIG. 5A but showing a fluid surge in a second direction.

FIG. 6 schematically illustrates in top plan view a fourth embodiment of the invention.

FIG. 7 schematically illustrates in enlarged front view the baffle of the embodiment featured in FIG. 6.

FIG. 8 schematically illustrates a cross-sectional view of the embodiment shown in FIG. 6 taken along line 8-8.

### DETAILED DESCRIPTION OF THE PREFERRED EMBODIMENTS

The invention relates generally to apparatuses and methods utilizing turbulent fluid flow to wash soiled items. A washing chamber that is connected to a pump contains a baffle that divides or partially divides the chamber into sub-chambers. The baffle contains one or more openings through which fluid surges in response to pressure generated by the pump. The turbulence created by the fluid surging through the baffle openings creates a “scrubbing action” upon the surface of the items being washed. By using, for example, a reciprocating piston or diaphragm-type pump, back-and-forth fluid flow is produced. Thus, cleaning efficacy may be improved and less detergent and other additives may be used.

Turning to the figures, wherein like numbers indicate like structures throughout the specification, a washing chamber 2 contains a baffle 5 disposed such that it divides the chamber 2 into sub-chambers 6 and 7. The baffle 5 contains openings (seen in FIG. 2) that allow water or another fluid to surge back-and-forth between sub-chambers 6 and 7 (shown schematically by arrows A and B) in response to pumping action generated by pump 10.

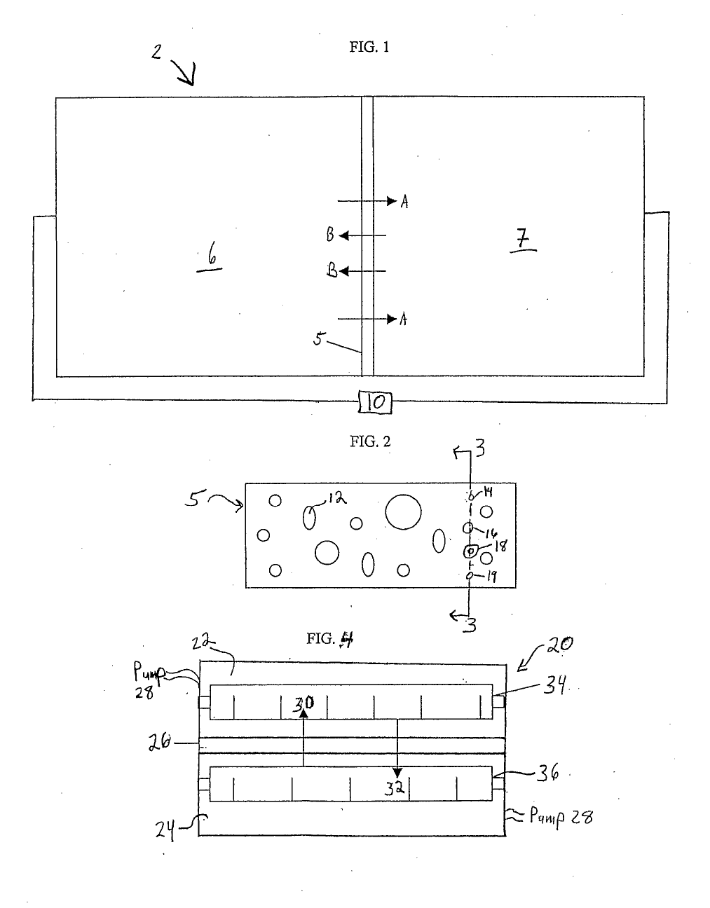

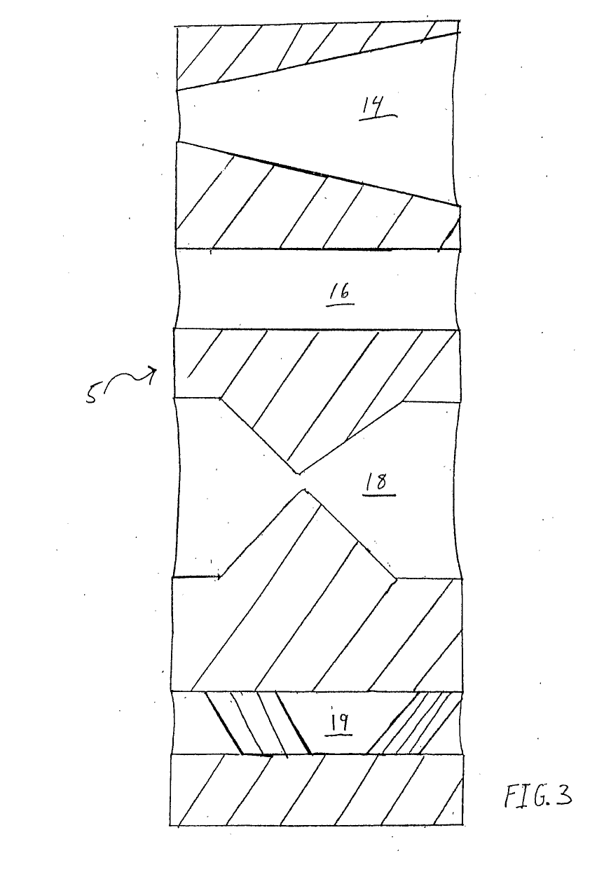

Thus, as seen in FIG. 2, the baffle 5 produces turbulent fluid flows within the sub-chambers 6 and 7 of FIG. 1 when fluid passes through openings 12, 14, 16, 18 and 19. While a generally rectangular shape is shown for baffle 5, it should be understood that other geometric configurations may also be used so long as a turbulent fluid flow can be produced. Moreover, the openings may vary in number, placement, and even diameter as shown in cross-section in FIG. 3. Openings of different size and shape produce differing turbulence effects that may be better suited to particular applications.

FIG. 3 illustrates a generally conical opening 14, a generally cylindrical opening 16, an irregularly configured opening 18, and a spiral opening 19 in baffle 5 (which has be magnified in this view for clarity). Openings 14, 16, 18, and 19 may be oriented in either direction.

Turning to FIG. 4, a washing embodiment of the invention is schematically depicted. The washing apparatus 20 includes a chamber 22 and chamber 24 that are divided by a baffle 26. A pumps 28 generate pressure that produces fluid flow between chamber 22 and chamber 24 in a back-and-forth fashion through openings in the baffle 26 as depicted by arrows 30 and 32. Items, such as dishes, are placed within racks 34 and 36.

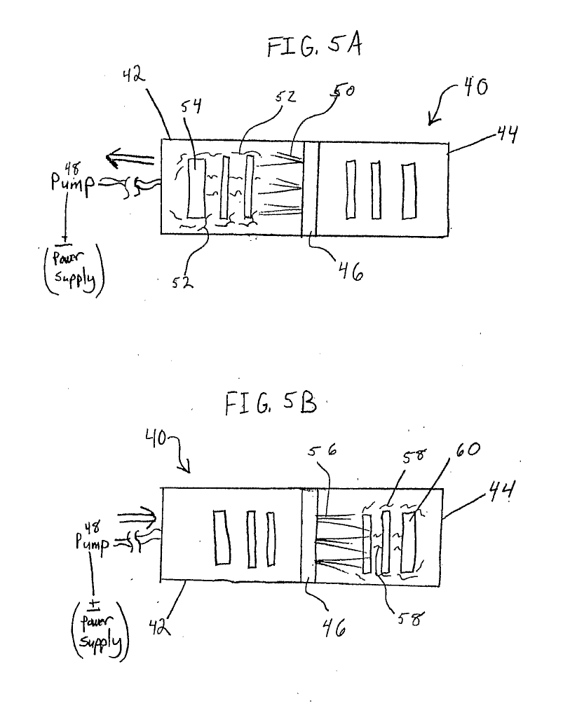

FIGS. 5A and 5B schematically illustrate an enclosed washing embodiment of the invention (with the cover removed) as it completes one cycle of fluid distribution. Pressurize-able chambers 42 and 44 are divided by baffle 46 such that when pump 48 produces fluid-withdrawing pressure, fluid surge 50 and turbulent flow 52 are created around items 54 in chamber 42. Conversely, when pump 48 produces a fluid-distributing pressure, fluid surge 56 and turbulent flow 58 are created around items 60 in chamber 44. The “pushing” and “pulling” of the fluid through the baffle opening(s) generate a desirable “scrubbing type” of effect in each chamber 42 and 44 as the fluid moves back and forth.

The synergistic effect produced by combining turbulent fluid flow with detergent or other chemical treatment regimens can increase cleaning options while reducing chemical amounts. For example, effective cleaning substances can be used in lesser amounts in difficult cleaning applications because the turbulent fluid flow provides an added “scrubbing action.” Such scrubbing action may better remove particularly difficult soils, such as “greasy residue,” lipids, oils, or cooked-on substances.

An embodiment of the method according to the invention for washing an item includes the steps of placing or securing (such as with a clamp or within a rack) the item into a pressurize-able chamber that is divided by a baffle, wherein the baffle contains at least one opening, and circulating a fluid through the chamber such that the fluid flows through the opening(s) of the baffle, thereby creating a turbulent flow of fluid.

In a typical cleaning cycle, a sufficient amount of fluid is placed into the chambers (may vary, but typically 50% or more of the surface of the item(s) being washed should be submerged in fluid to ensure that its exterior is wetted and exposed to the washing action). In many cleaning applications, water preferably is used in combination with a detergent. A chemical rinsing or other chemical agent may also be added to the system.

For example, a washing apparatus 66 is used according to that illustrated in FIGS. 6-8. A soiled item 67 (shown in phantom line through cover 68) is positioned in apparatus 66 such that water surging through the openings in baffle 70 with generate a turbulent flow over the item 67. The baffle between the chambers need not be an absolute or complete partition in part because turbulence is created by edges as well as openings 74 and 76. In addition, openings 74 are disposed along the bottom of baffle 70 to prevent sediment from building up on one side of the baffle and potentially clogging the openings 76.

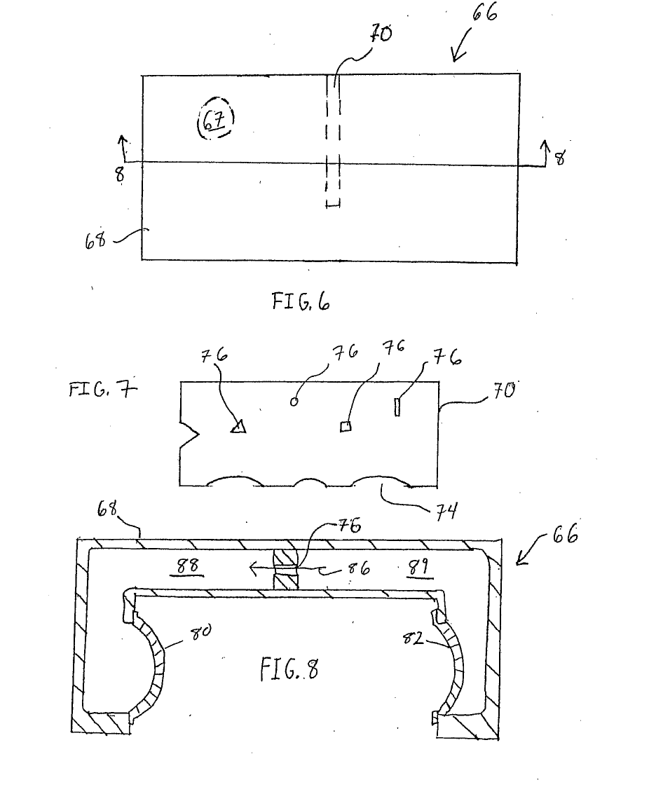

The baffle 70 creates the fluid “surge” (arrow 86) through the use of a diaphragm-type pump 80 and 82 (see FIG. 8). By deforming the diaphragms 80 and 82 (inward and outward), a pressure or suction is created which results in a flow (liquid displacement) between the chambers 88 and 89 to equalize the pressure between them.

A desirable washing cycle would include 50 ml of detergent added to 10 liters of water, which is used to wash the item 67 for 10 min. The item 67 is then rinsed twice for 5 minutes each with 5 liters of water. Those of ordinary skill in the art readily recognize various other chemical additives which can be used in this context.

Various changes in the details and components that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products.

1. A method for washing an item, comprising the steps of:
(a) securing said item into an enclosed chamber that is divided by a baffle, wherein said baffle contains at least one opening therethrough; and
(b) circulating a fluid through said chamber such that the fluid flows back-and-forth through said at least one opening of the baffle, thereby generating a turbulent fluid flow over an exterior of said item.

2. The method of claim 1, wherein said chamber is pressurized.

3. (canceled)

4. The method of claim 1, wherein said item is placed within said enclosed chamber such that it is not in contact with said at least one opening in said baffle.

5. A method for washing an item, comprising the steps of:
(a) securing said item into an enclosed chamber that is partially divided by a baffle, wherein said baffle contains at least one opening therethrough; and
(b) circulating a fluid through said chamber such that the fluid flows back-and-forth through said at least one opening of the baffle, thereby generating a turbulent fluid flow over an exterior of said item.

6. The method of claim 5, wherein said chamber is pressurized.

7. (canceled)

8. The method of claim 5, wherein said item is placed within said enclosed chamber such that it is not in contact with said at least one opening of said baffle.

9. An apparatus for cleaning an item, comprising:
(a) an enclosed chamber divided by a baffle, wherein said baffle contains at least one opening therethrough,
(b) a means for securing said item within said chamber; and
(c) a pumping means in fluid connection with said chamber, wherein a back-and-forth turbulent fluid flow is produced over an exterior of said item as a result of fluid flowing through said at least one opening of the baffle.

10. The apparatus of claim 9, wherein said pumping means includes a diaphragm.

11. The apparatus of claim 9, wherein said enclosed chamber contains at least one rack.

12. (canceled)

13. The apparatus of claim 9, wherein said enclosed chamber is pressurized.

14. The apparatus of claim 9, wherein said at least one opening of said baffle transversely varies in diameter.

15. The apparatus of claim 9, wherein said baffle contains two or more openings.

16. The apparatus of claim 9, wherein said baffle contains two or more openings of different diameters.

17. An apparatus for cleaning an item, comprising:
(a) an enclosed chamber partially divided by a baffle, wherein said baffle contains at least one opening therethrough,
(b) a means for securing said item within said chamber; and
(c) a pumping means in fluid connection with said enclosed chamber, wherein a back-and-forth turbulent fluid flow is produced over an exterior of said item as a result of fluid flowing through said at least one opening of the baffle.

18. The apparatus of claim 17, wherein said pumping means includes a diaphragm.

19. The apparatus of claim 17, wherein said enclosed chamber contains at least one rack.

20. (canceled)

21. The apparatus of claim 17, wherein said enclosed chamber is pressurized.

22. The apparatus of claim 17, wherein said at least one opening of said baffle transversely varies in diameter.

23. The apparatus of claim 17, wherein said baffle contains two or more openings.

24. The apparatus of claim 17, wherein said baffle contains two or more openings of different diameters.

25. A cleaning system, comprising:
(a) an enclosed chamber, said enclosed chamber being at least partially divided by a baffle containing at least one opening therethrough,
(b) an item to be cleaned secured within said enclosed chamber and free of contact with said baffle and;
(c) a pumping means in fluid connection with said enclosed chamber, wherein a back-and-forth turbulent fluid flow is produced over an exterior of said item as a result of fluid flowing through said at least one opening of the baffle.
